(19) United States
(12) Patent Application Publication
(10) Pub. No.: US 2012/0212042 A1
(43) Pub. Date: Aug. 23, 2012

(54) HYDRAULIC ASSEMBLY AND BRAKE SYSTEM FOR A MOTOR VEHICLE

(75) Inventor: Michael Kunz, Steinheim An Der Murr (DE)

(73) Assignee: ROBERT BOSCH GMBH, Stuttgart (DE)

(21) Appl. No.: 13/503,099

(22) PCT Filed: Sep. 3, 2010
(86) PCT No.: PCT/EP2010/062928

§ 371 Date: Apr. 20, 2012

(30) Foreign Application Priority Data
Nov. 2, 2009 (DE) 10 2009 046 273.2

(51) Int. Cl. B60T 13/58; B60T 1/10; B60T 13/16

(52) U.S. Cl. 303/2; 303/10

(57) ABSTRACT

A hydraulic assembly for operating a brake system in a motor vehicle is described, the hydraulic assembly including a hydraulic pump, an electric motor having a shaft for driving the hydraulic pump, and a rotor which is operatively linked to the shaft of the electric motor for the purpose of driving the shaft with the aid of compressed air.

### BACKGROUND INFORMATION

Conventionally, in decelerating a motor vehicle, decelerating elements are used for relieving the load on the brakes. Decelerating elements of this type are also generally known as so-called working assemblies. For example, working assemblies which relieve the load on the brake when the motor vehicle decelerates and which convert the released kinetic energy to electrical energy, which may then be temporarily stored in a battery, are known in the form of a generator in hybrid vehicles, for example. The generator may subsequently be operated again as a motor to accelerate the vehicle, using the electrical energy stored in the battery. This is known, in particular, as a regenerative brake.

For example, a regenerative brake of this type is described in European Patent No. EP 1 795 412 A2 for an electrically driven motor vehicle. However, other storage units which are able to convert kinetic energy to potential energy are equally possible, for example flywheel storage units, hydraulic converters having a hydraulic storage unit or the like.

In connection with regenerative brakes, it should furthermore be mentioned that a highly dynamic pressure buildup is often impossible to achieve in conventional brake systems without additional measures. Special devices therefore exist which are built into the suction path of the hydraulic pump to increase the admission pressure, for example by providing a pressure reservoir. For example, a corresponding externally controllable electrohydraulic vehicle brake system is described in German Patent Application No. DE 10 2007 036 859 A1, in which appropriate additional measures are taken.

However, additional measures of this type increase the manufacturing costs and also make such brake systems overall more susceptible to interferences.

### SUMMARY

An object of the present invention is to provide an improved system for converting and storing kinetic energy when decelerating the motor vehicle, including subsequent recovery of this energy in the form of electrical and/or mechanical energy. A further object of the present invention is to implement short pressure buildup times without additional measures, i.e., to provide an overall brake system which efficiently stores the kinetic energy released during deceleration of the motor vehicle for recovery purposes, on the one hand, and which may be manufactured at low manufacturing cost, on the other hand.

According to a first example aspect of the present invention, a hydraulic assembly is provided for operating a brake system in a motor vehicle, including a hydraulic pump, an electric motor which has a shaft for driving the hydraulic pump, and a rotor which is operatively linked to the shaft of the electric motor for the purpose of driving the shaft with the aid of compressed air.

According to a specific example embodiment of the present invention, the hydraulic assembly is designed to electrically drive the hydraulic pump with the aid of the electric motor in a first operating mode, to drive the hydraulic pump with the aid of compressed air via the rotor in a second operating mode, and to drive the electric motor with the aid of compressed air via the rotor for the purpose of generating electrical energy in a third operating mode.

According to a further example aspect of the present invention, a brake system for a motor vehicle is provided, the brake system including a hydraulic assembly according to a specific example embodiment of the present invention, an air compressor for driving the motor vehicle with the aid of the rotational movement of a wheel axle and a pressure reservoir for storing compressed air from the air compressor and for transfer to the rotor of the hydraulic assembly.

Consequently, according to a specific example embodiment of the present invention, a motor in a hydraulic assembly may be driven redundantly, i.e., simultaneously or alternately, using an electrical or mechanical arrangement. The load on the hydraulic assembly may thus be significantly relieved during hydraulic pressure buildup in the wheel brake cylinder. Furthermore, the hydraulic assembly may also feed electrical energy back into the electrical system of the motor vehicle by being driven mechanically using the previously stored energy. A hydraulic assembly or brake system according to the present invention may thus be used, for example, in electrohydraulic brake systems which are already in common use, such as an anti-lock braking system (ABS) or in the form of a so-called electronic stability program (ESP).

On the whole, therefore, a battery may be charged with the mechanically generated electrical energy, or the mechanical energy may be converted directly to a torque for accelerating the motor vehicle, for example in a hybrid vehicle, or to drive a generator, or both may be used simultaneously.

Advantageous example embodiments of the present invention are explained in greater detail below.

### BRIEF DESCRIPTION OF THE DRAWINGS

FIG. 1 shows a schematic diagram and system components for regenerating energy in a brake system.

FIG. 2 shows a hydraulic circuit in a motor vehicle brake system.

### DETAILED DESCRIPTION OF EXAMPLE EMBODIMENTS

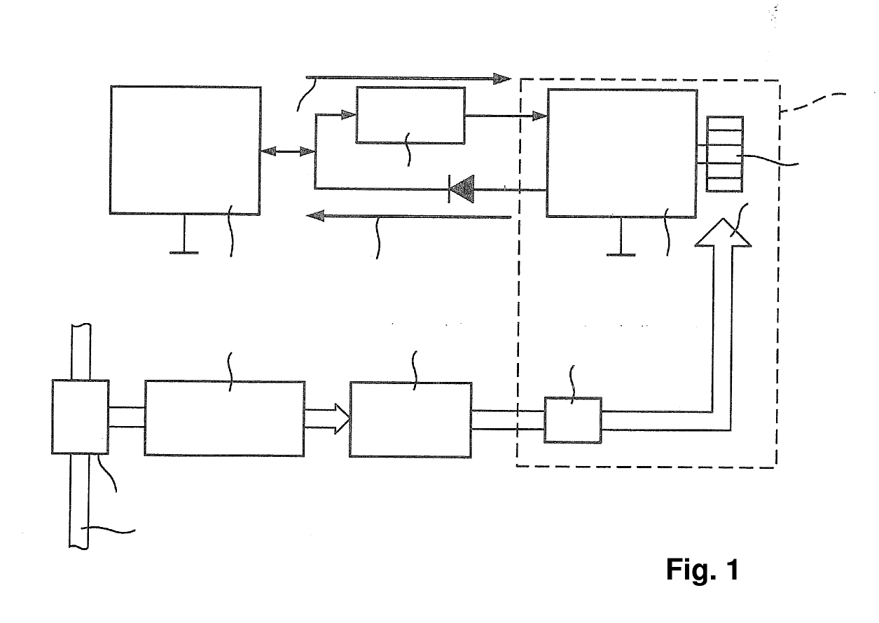

FIG. 1 shows a schematic diagram of a brake system according to the present invention in a specific example embodiment of the present invention. A hydraulic assembly 1, including a motor 11 and a rotor 12, is provided. Rotor 12 may be designed, for example, as a compressed air turbine. Motor 11 is an electric motor and may be operated both as a motor and as a generator. Rotor 12 is operatively linked by its axle to the axle of motor 11 and may be driven by a nozzle 13 with the aid of compressed air. A control valve 14 may furthermore be provided within hydraulic assembly 1 for controlling a compressed air flow to nozzle 13.

Within the motor vehicle, a compressor 3 is coupled to a mechanical drive or wheel axle 32 of the motor vehicle with the aid of a clutch 31. Here, axle 32 is generally an axle which is capable of transmitting mechanical energy from the kinetic energy of the motor vehicle to compressor 3. If clutch 31 is engaged, i.e., if mechanical energy is being transmitted from axle 32 to compressor 3 via clutch 31, compressor 3 generates compressed air which is stored in a compressed air reservoir 2. The compressed air stored therein may be supplied to nozzle 13 via control valve 14 for driving rotor 12.

Furthermore, an electronic control unit (ECU) 4 may be provided for controlling the energy flow from hydraulic assembly 1. In one operating mode, energy may be supplied to motor 11 from a battery or vehicle electrical system 5 for driving a hydraulic pump (energy flow 61). In a further operating mode, rotor 12 may then be driven with the aid of compressed air from compressed air reservoir 2 to operate motor 11 as a generator, which then supplies electrical energy to the battery or vehicle electrical system 5 (energy flow 62).

Compressor 3 is therefore provided as the working assembly for decelerating the vehicle and recovering energy, the compressor being mechanically driven by axle 32 during deceleration of the motor vehicle and thereby inducing a deceleration and simultaneously filling compressed air reservoir 2 with compressed air. To recover the energy, motor 11 in hydraulic assembly 1 is provided with rotor 12 on an accessible end of its rotor shaft, and the rotor may then be mechanically driven via nozzle 13 with the aid of the compressed air from compressed air reservoir 2. Motor 11 of hydraulic assembly 1 may thus as a whole be operated both electrically and mechanically via rotor 12 from two energy accumulators at the same time, with the aid of compressed air.

As a whole, the present invention thus provides a hydraulic assembly 1 with a versatile functionality. The motor thus has a redundant design with regard to its mechanically transferred torque, so that it may be operated both electrically from vehicle electrical system 5 and using compressed air from compressed air reservoir 2. Generally speaking, motor 11 may be electrically driven in a first operating mode and driven via rotor 12 with the aid of compressed air in a second operating mode, and motor 11 may be driven as a generator via rotor 12, with the aid of compressed air, in a third operating mode for the purpose of generating electrical energy. These operating modes are independent of each other and may each operate individually or in parallel.

In mixed mode, i.e., using a combination of the aforementioned first and second operating modes in the form of a drive motor, total torque M_ges is the sum of the individual torques, i.e.,

M_{—}ges=M_{—}el+M_air,

using torque M_el of electric motor 11 from vehicle electrical system 5 and torque M_air of rotor 12 via the compressed air.

This makes it possible, for example, to completely relieve the load on vehicle electrical system 5 if the entire torque may be withdrawn from the compressed air reservoir. Conversely, motor 11 may also be operated by battery 5, as it has been the case hitherto, if, for example, pressure reservoir 2 is empty. In addition, the high starting current from a standstill of motor 11 may be prevented if motor 11 is brought to an initial rotational speed with the aid of rotor 12 and using compressed air from compressed air reservoir 2 before battery 5 is activated.

In mixed mode, a gradual to full relief of the load on vehicle electrical system 5 is thus possible, since the total torque is the sum of the individual torques. The components of the compressed air and electrical energy, weighted in any manner, are added up to the total torque. The operating mode may be constituted in such a way that, if the necessary torque cannot be achieved with the aid of the compressed air, motor 11 may add the missing torque from vehicle electrical system 5. Conversely, the electric torque may be reduced by the amount that a torque provides from the compressed air. Finally, it is also possible to amplify the entire electric torque by driving motor 11 at full electric power and by adding the portion from the compressed air via rotor 12.

On the whole, the situation may be the same as in a regenerative braking process. That is, in regenerative braking the total braking torque is the sum of the working assemblies and the hydraulic brake of an axle, for example the front axle. The portion which the working assemblies are incapable of providing may then be added by the hydraulic rear axle brake.

When the deceleration process of the motor vehicle is concluded, motor 11 may be operated as a generator by being driven from compressed air reservoir 2 via rotor 12. Motor 11 then feeds electrical energy back to vehicle electrical system 5 so that a separate generator, such as that used in a hybrid vehicle, may possibly be dispensed with.

In a so-called initial braking process of the motor vehicle, a high motor speed may furthermore be desired to bridge the air gap and to ensure deceleration-free pressure buildup. According to the present invention, this may also be carried out in a further advantageous manner if air is supplied to rotor 12 with correspondingly high pressure from compressed air reservoir 2, causing it to rotate at high speed. If the dynamics thus achieved are still insufficient, the rotational speed may be further supported by electric motor 11 with the aid of energy from vehicle electrical system 5.

If hydraulic assembly 1 as a whole is to be operated in a counterclockwise as well as a clockwise direction, at least two nozzles may be provided within hydraulic assembly 1 to be able to supply air to or drive rotor 12 from two opposite directions. In this case, additional control valves may also be provided within hydraulic assembly 1.

In general, it may furthermore be provided within the present invention that a further pressure buildup within the hydraulic system of the brake system is omitted in the generating mode of motor 11, i.e., in the event that the motor is driven by rotor 12. To prevent a further hydraulic pressure buildup in the generating mode, it may generally be provided to provide corresponding bypasses within the hydraulic assembly or to provide a clutch between the shaft of motor 11 and the drive shaft of the hydraulic pump.

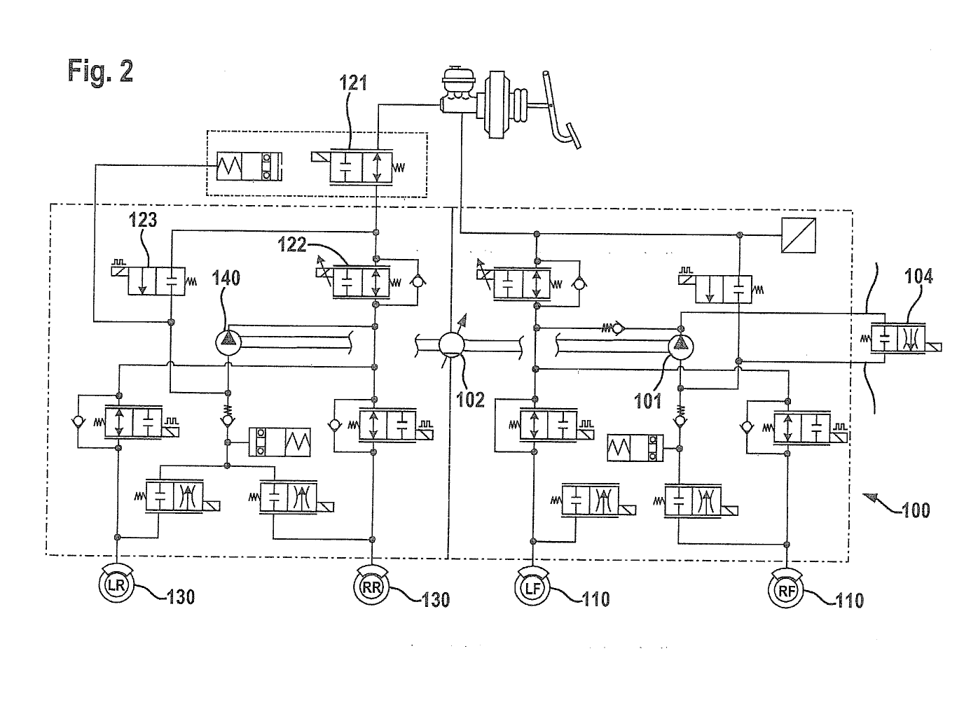

For this purpose, FIG. 2 shows a hydraulic circuit within a motor vehicle brake system. Here, FIG. 2 shows a brake system 100 for braking up to four motor vehicle wheels 110, 130. A motor 102 is provided within brake system 100 to mechanically drive hydraulic pumps 101, 140. This motor 102 may be designed in the same manner as motor 11 including rotor 12 from FIG. 1. It may then be provided that the suction side and the pressure side of hydraulic pump 101 are connected via appropriate tap lines 103A and 103B via a short circuit valve 104. In the event that short circuit valve 104 is opened, the hydraulic fluid is circulated even when driving hydraulic pump 101, so that the hydraulic pressure within brake system 100 is not substantially increased. The hydraulic pressure in the wheel brake cylinders is thus not increased during this process, i.e., no pressure is built up therein.

It may furthermore be provided within brake system 100 to connect additional valves 121, 122 and 123 in such a way that the brake fluid is also circulated for wheels 130 of the rear axle. No pressure is thus built up for the wheel brake cylinders corresponding to rear wheels 130 either. For this purpose, in particular, a valve 121 may be blocked and valves 122 and 123 may be opened so that the hydraulic fluid also circulates through pump 140.

According to another specific example embodiment, it is furthermore possible, in a hybrid vehicle, to also support the electric motor for driving the motor vehicle with compressed air from compressed air reservoir 2 via a corresponding rotor during the acceleration phase and to thereby obtain direct recirculation of mechanical energy. The compressor and the generator may thus be integrated into a single housing in a further advantageous manner and be driven by a common shaft. This makes it possible to use the present invention in a hybrid vehicle as well as in a motor vehicle which has an internal combustion engine.

On the whole, it is thus possible to add the electric torque and the mechanical torque in a so-called mixed mode as well as to operate the motor as a purely electric motor using electrical energy supplied from the battery without compressed air support as well as to operate the motor as a purely mechanical motor by driving it using compressed air without supplying electrical energy. This may, on the whole, relieve the load on the vehicle electrical system of the motor vehicle and thus increase the torque by providing compressed air support without placing additional load on the battery (I_Bat1=I_Bat2; M2>M1). Loading the vehicle electrical system may furthermore be prevented by providing this same compressed air support (I2<I1; M1=M2). This makes it possible to recirculate energy to the vehicle electrical system of the motor vehicle by driving the motor with the aid of compressed air from the compressor and also by operating the motor as a generator.

On the whole, the motor dimensioning in a hydraulic assembly may thus be reduced, which may have an advantageous effect on both the weight and the mechanical dimensions. In particular, the load may be reduced and the life of the hydraulic assembly overall may also be increased in a further advantageous manner. Also, independently of the recirculation of mechanical energy, a highly dynamic brake pressure buildup may be provided by a fast revving of the motor when starting the braking process. Overall, a highly dynamic emptying of the accumulator chamber is thus also possible during ABS braking, and a pressure reservoir or assemblies for generating admission pressure (e.g., bellows, spring pressure, stepped pistons, etc.) may also be eliminated.

According to a further specific embodiment of the present invention, the generator, which is otherwise used to recover electrical energy from the kinetic energy of the motor vehicle, may be dispensed with in a hybrid vehicle. The compressor having the pressure reservoir may then be the sole working assembly which stores braking energy. Electrical energy is then recovered via the motor, which is mechanically driven as a generator from the compressed air reservoir via the nozzles and the rotor. According to a further specific embodiment of the present invention, the main drive motor in a hybrid vehicle may also be provided with a further rotor to which compressed air from the pressure reservoir may directly be supplied for accelerating the motor vehicle or for supporting its acceleration.

In general, it is furthermore also possible for the compressor to operate continuously. If the pressure reservoir is full, and further pressure buildup therein is therefore undesirable, a pressure relief valve may be provided to provide the compressor with a counter-pressure and/or to prevent an impermissible rise in pressure in the compressed air reservoir.

On the whole, the present invention is also an innovative and advantageous refinement of pneumatic auxiliary assemblies and, on the whole, is also an environmentally friendly brake system, since only compressed air is processed. In implementing a hydraulic assembly according to the present invention or a brake system according to the present invention, perfected and known techniques and components which are known, for example, from the area of pneumatic brakes, may be used in a further advantageous manner. On the whole, a hydraulic assembly according to the present invention and a brake system according to the present invention may thus be reliably used in a further advantageous manner in both a hybrid vehicle and in a normal motor vehicle having an internal combustion engine.

1-10. (canceled)

11. A hydraulic assembly for operating a brake system in a motor vehicle, comprising:
a hydraulic pump;
an electric motor having a shaft for driving the hydraulic pump; and
a rotor which is operatively linked to a shaft of the electric motor to drive the shaft with the aid of compressed air.

12. The hydraulic assembly as recited in claim 11, wherein the rotor is situated at an accessible end of the shaft of the electric motor.

13. The hydraulic assembly as recited in claim 11, wherein the hydraulic assembly is configured to electrically drive the electric motor in a first operating mode, drive the electric motor via the rotor with the aid of compressed air in a second operating mode, and drive the electric motor via the rotor with the aid of compressed air in a third operating mode to generate electrical energy.

14. The hydraulic assembly as recited in claim 11, further comprising:
a nozzle, air flowing through the nozzle to drive the rotor.

15. The hydraulic assembly as recited in claim 14, wherein the hydraulic assembly includes at least two nozzles to drive the rotor in both the counter-clockwise and clockwise directions.

16. The hydraulic assembly as recited in claim 11, further comprising:
a clutch to engage and disengage an operative connection between the shaft of the electric motor and the hydraulic pump.

17. The hydraulic assembly as recited in claim 11, further comprising:
a valve for short circuiting a suction side of the hydraulic pump to a pressure side of the hydraulic pump.

18. A brake system for a motor vehicle, comprising:
a hydraulic assembly including a hydraulic pump, an electric motor having a shaft for driving the hydraulic pump, and a rotor which is operatively linked to a shaft of the electric motor to drive the shaft with the aid of compressed air;
an air compressor to drive the shaft with the aid of rotational movement of a wheel axle of the motor vehicle; and
a pressure reservoir for storing compressed air from the air compressor and for transferring the compressed air to the rotor of the hydraulic assembly.

19. The brake system as recited in claim 18, further comprising:
a clutch to engage with and disengage from the air compressor the wheel axle.

20. The brake system as recited in claim 18, further comprising:
an electronic control unit which drives the brake system in a deceleration state of the motor vehicle in such a way that the air compressor accommodates kinetic energy of the motor vehicle and drives the brake system in an acceleration state of the motor vehicle in such a way that electrical energy for driving the motor vehicle is provided in the third operating mode of the hydraulic assembly.
